(19) United States
(12) Patent Application Publication
(10) Pub. No.: US 2024/0084638 A1
(43) Pub. Date: Mar. 14, 2024

(54) PROGRAMMATIC HATCH OPENING CAPABILITY OF AUTONOMOUS TRANSPORTATION VEHICLE

(71) Applicant: INTERNATIONAL BUSINESS MACHINES CORPORATION, ARMONK, NY (US)

(72) Inventors: Jeremy R. Fox, Georgetown, TX (US); Mauro Marzorati, Lutz, FL (US); Carolina Garcia Delgado, Zapopan (MX); Sarbajit K. Rakshit, Kolkata (IN)

(21) Appl. No.: 17/930,733

(22) Filed: Sep. 9, 2022

(51) Int. Cl. E05F 15/70

(52) U.S. Cl. CPC E05F 15/70; B60J 5/108

(57) ABSTRACT

According to one embodiment, a method, computer system, and computer program product for contextual accessway opening is provided. The embodiment may include determining an occurrence of an activity utilizing a vehicle access point is to occur within a preconfigured period of time. The embodiment may also include identifying a contextual orientation of a door of the vehicle access point based on environmental data and historical data. The embodiment may further include generating a plan to orient the door according to the identified contextual orientation. The embodiment may also include performing the generated plan.

### BACKGROUND

The present invention relates generally to the field of computing, and more particularly to autonomous vehicles.

Autonomous vehicles are vehicles that are capable navigation without human intervention using sensors to guide the performance of driving tasks. Employing an autonomous vehicle capable of sensing the surrounding environment and navigating without human input has the potential to decrease the human errors that lead to automobile accidents, since many automobile accidents can be attributed to some form of human error, such as delayed reaction time, tailgating, rubbernecking, and other forms of distracted or aggressive driving. Autonomous vehicles rely heavily on cloud computing integration to communicate with each other to avoid accidents, download up-to-date maps and traffic data, and to create efficient routes to a driver's destination.

### SUMMARY

According to one embodiment, a method, computer system, and computer program product for contextual accessway opening is provided. The embodiment may include determining an occurrence of an activity utilizing a vehicle access point is to occur within a preconfigured period of time. The embodiment may also include identifying a contextual orientation of a door of the vehicle access point based on environmental data and historical data. The embodiment may further include generating a plan to orient the door according to the identified contextual orientation. The embodiment may also include performing the generated plan.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a contextual accessway opening process according to at least one embodiment.

FIGS. 3A-3E depict block diagrams of various orientations of a multi-hinged access door according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to autonomous vehicles. The following described exemplary embodiments provide a system, method, and program product to, among other things, identify and perform an appropriate orientation for opening an access point to an autonomous vehicle based on the contextual surroundings. Therefore, the present embodiment has the capacity to improve the technical field of autonomous vehicles by utilizing the contextual surroundings of an autonomous vehicle to modify the mechanisms for opening the access points (e.g., doors, tailgates, and loading hatches) to best suit the current situation.

As previously described, autonomous vehicles are vehicles that are capable navigation without human intervention using sensors to guide the performance of driving tasks. Employing an autonomous vehicle capable of sensing the surrounding environment and navigating without human input has the potential to decrease the human errors that lead to automobile accidents, since many automobile accidents can be attributed to some form of human error, such as delayed reaction time, tailgating, rubbernecking, and other forms of distracted or aggressive driving. Autonomous vehicles rely heavily on cloud computing integration to communicate with each other to avoid accidents, download up-to-date maps and traffic data, and to create efficient routes to a driver's destination. In a modern commercial and industrial setting, autonomous vehicles are becoming ever more present in vehicle-oriented settings, such as taxi services, ride sharing, and commercial transport and delivery.

Most vehicles are equipped with hinged doors that allow for access to the cabin and storage areas of the vehicle for passenger entry and exit and storage loading and unloading, respectively. Based on vehicle type and model, the hinged door may open in a variety of directions, such as upwards for a hatchback or downwards for a tailgate. However, due to the nature of autonomous vehicles, the way in which a vehicle determines to park itself to allow for loading and unloading of passengers and/or goods may not always be fully conducive to such tasks based on the environmental surroundings of the vehicle. For example, an autonomous vehicle may park next to a pillar opening a tailgate impossible without damaging the vehicle. As such, it may be advantageous to, among other things, determining the contextual need of an access point of an autonomous vehicle and modifying the access point in a manner that is most conducive to performing the determined contextual need.

According to at least one embodiment, while in operation, an autonomous vehicle may identify a contextual need for a task to be performed at a given point in time. For example, opening a trailer door for the loading or unloading of items. Once a need has been identified, the environmental and contextual surroundings may be analyzed to determine a most appropriate access point orientation to utilize for the contextual need. Utilizing a one or more door and hinge arrangements, the autonomous vehicle may perform an opening of the appropriate access point in a manner identified as a best fit corresponding to the contextual need. In at least one embodiment, the access point doorway may allow for hinging at various anchoring points along the door frame as well as a door itself containing an array of pivotal hinges that allow for a configuration of the door to a shape most conducive to the identified contextual need.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

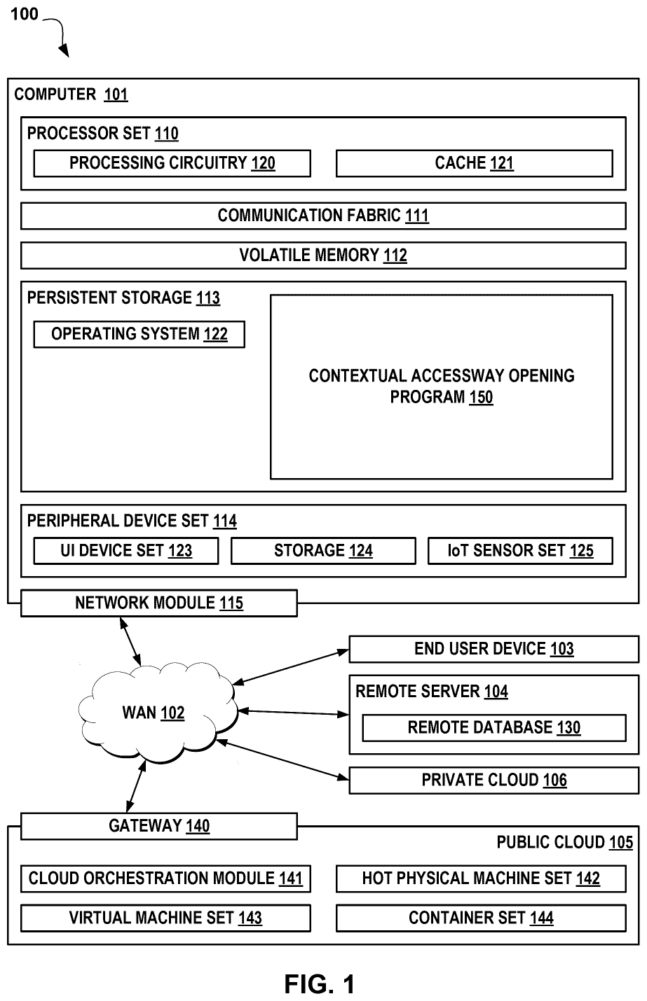

Referring now to FIG. 1, computing environment 100 contains an example of an environment for the execution of at least some of the computer code involved in performing the inventive methods, such as contextual accessway opening program 150. In addition to contextual accessway opening program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and contextual accessway opening program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in contextual accessway opening program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in contextual accessway opening program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to at least one embodiment, the contextual accessway opening program 150 may identify how a vehicle door is to be opened based on a contextual setting and effectuate the orientation of the door. In at least one embodiment, the vehicle door may consist of an array of thin, flat surface panels connected by hinges, aligned in parallel and capable of movement in two directions, that enables effective loading or unloading of passengers or cargo according to the identified contextual setting. In at least one embodiment, the hinges utilized within the door array of flat surface panels may be of varying types including, but not limited to pivot hinges, butt hinges, spring-loaded hinges, concealed hinges, overlay hinges, strap hinges, ball-bearing hinges, offset hinges, scissor hinges, continuous hinges, double-action spring hinges, and knuckle hinges. The contextual accessway opening program 150 may also utilize and control one or more pistons, hydraulic arms, pneumatic devices, or motors to provide support, strength, and guidance to the autonomous vehicle door when opened to the identified orientation. In at least one other embodiment, the door consisting of an array of flat surface panels connected by hinges aligned in parallel may include one or more motors or actuators and locking mechanisms that enable each hinge to move into the identified orientation. For example, if the identified orientation is a set of stairs descending from a box truck to the ground, one or more motors or actuators may be utilized to position and lock each hinge into the desired position to create a set of stairs. Despite the above examples including a door consisting of an array of flat surface panels connected by hinges aligned in parallel, the contextual accessway opening program 150 may, in another embodiment, utilize a standard rigid door only capable of pivoting on hinges affixed to a door frame surface. Regardless of the make up of the door (e.g., rigid or pivotal hinges), the door may be capable of supporting the weight of loading into and unloading out of the vehicle in the orientation determined for the identified task to be performed. The contextual accessway opening program 150 may be utilized in an any vehicle with a multi-purpose-based hatch or door that can be programmed to react to various type of situation and scenarios. Use case examples of vehicles may include, but are not limited to, trucks, cars, vans, semi-tractor trailers, aircraft, spacecraft, boats, ships, submarines, buses, trains, trams, trolleys, and railcars.

Additionally, in at least one embodiment, the access point (e.g., vehicle door) may have hinges of one or more varieties installed along different surfaces of the frame (e.g., top, bottom, side) and allow for engaging and disengaging of specific frame-attached hinges based on the identified orientation. For example, in one orientation, the contextual accessway opening program 150 may identify that the door to swing left when opened and will only engage hinges on the left side of the frame. Similarly, in another orientation, the contextual accessway opening program 150 may identify that the door should swing right when opened and will only engage hinges on the right side of the frame. In another embodiment, the access point may allow for the operation of hinges on opposing, parallel surfaces of the door frame to be engaged while hinges on perpendicular sides to the engaged hinges are disengaged. This hinge orientation may allow for the operation of a split door where one door pivots on one set of hinges and the other door pivots on the parallel set of hinges. In an embodiment that utilizes an array of pivotal, flat panels for the door, the contextual accessway opening program 150 may be capable of disengaging hinges from panels to create a custom-sized door based on the contextual situation needed to open the door and perform the identified task. For example, if an obstacle is obstructing the complete opening of a box truck door that would normally open right on one set of hinges, the contextual accessway opening program 150 may determine to engage hinges on two opposing door frame surfaces and disengage certain hinges within the array panels that make up the door to create two smaller doors capable of fully swinging outward. In this example, the size of the smaller doors may be equal but the contextual accessway opening program 150 may also be capable of making each door any percentage smaller than the original door allowable (e.g., 33%/66% and 25%/75%).

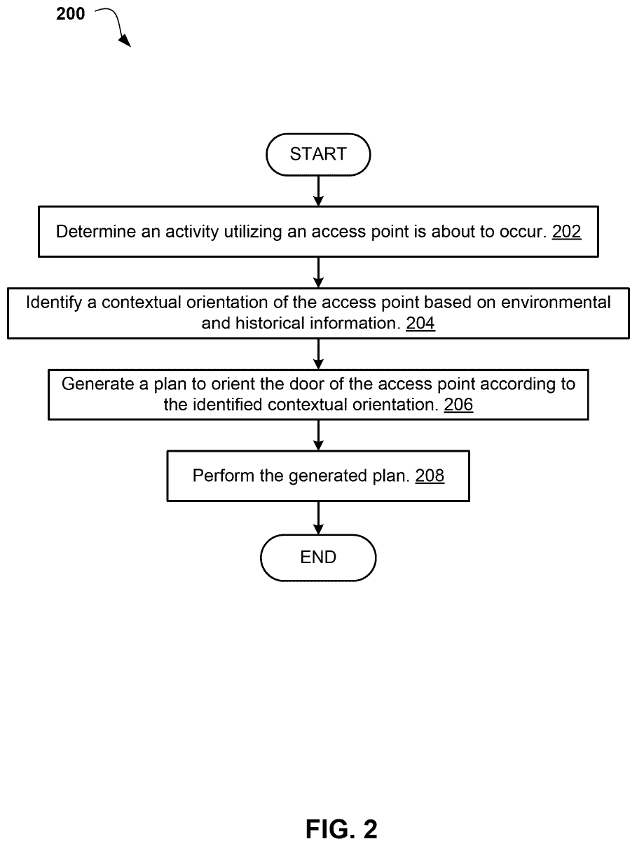

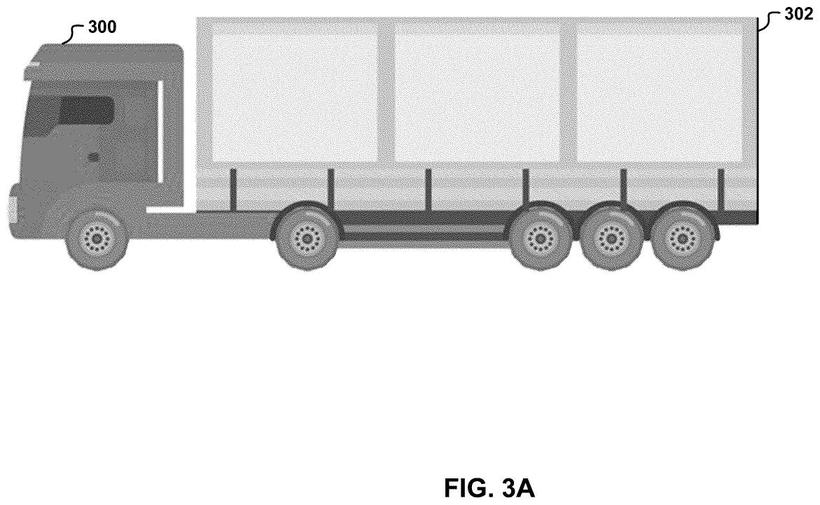

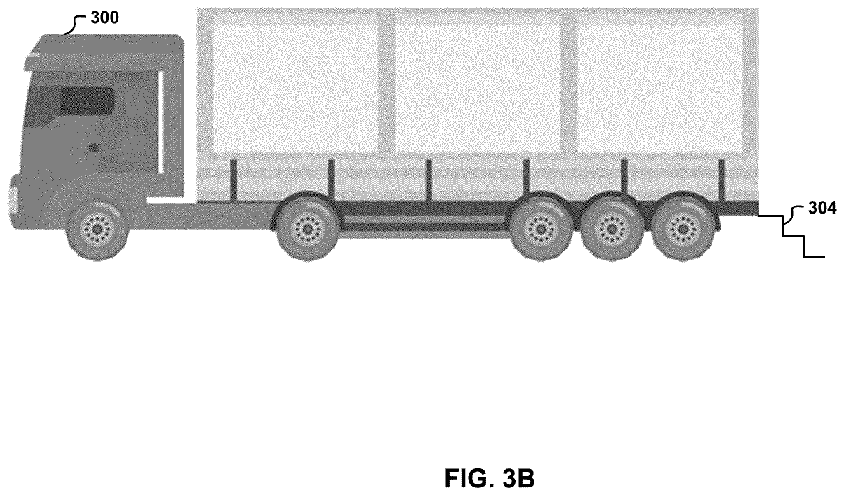

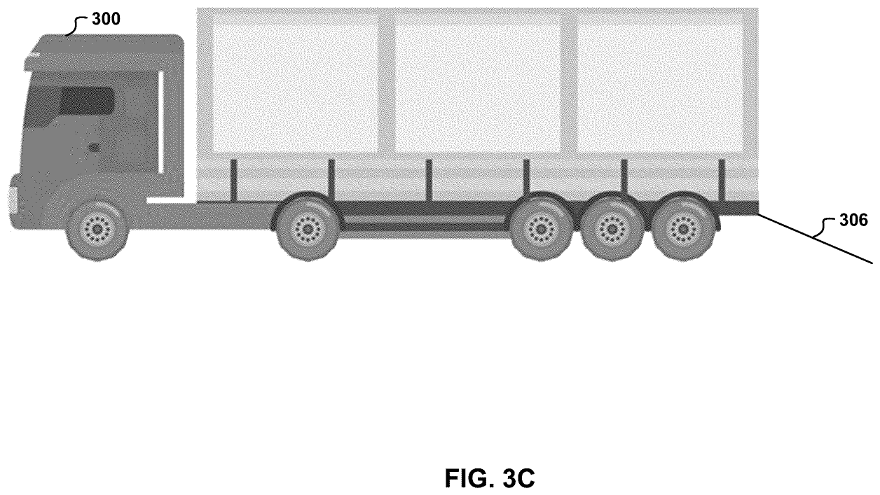

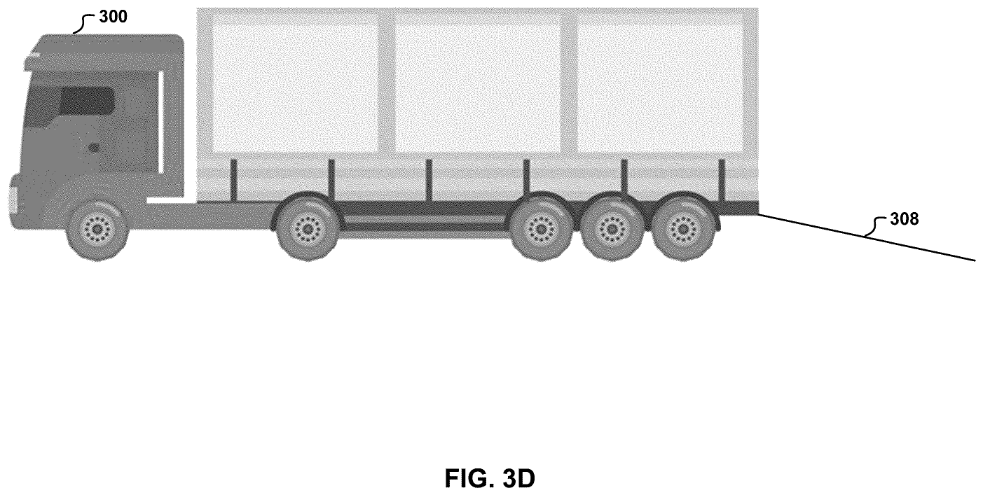

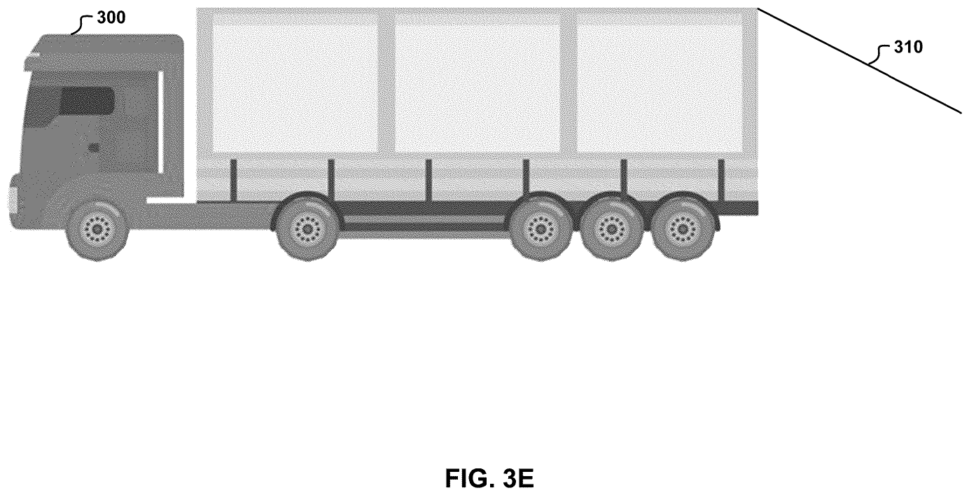

Furthermore, notwithstanding depiction in computer 101, the contextual accessway opening program 150 may be stored in and/or executed by, individually or in any combination, end user device 103, remote server 104, public cloud 105, and private cloud 106. The contextual accessway opening method is explained in more detail below with respect to FIGS. 2 and 3A-3E.

Referring now to FIG. 2, an operational flowchart for a contextual accessway opening process 200 is depicted according to at least one embodiment. At 202, the contextual accessway opening program 150 determines an activity utilizing an access point is about to occur. Utilizing on-board (e.g., embedded or communicatively coupled to the vehicle) sensors (e.g., cameras) or even available IoT sensors, the contextual accessway opening program 150 may be capable of determining when an activity is about to occur and identify what the activity is likely to be. For example, using on-board cameras, the contextual accessway opening program 150 may determine that a user loaded a vehicle with items at a previous stop and has just returned to a home location. As such, the contextual accessway opening program 150 may determine that an activity is about to occur and, based on the context of loading a vehicle and returning to a home location, the contextual accessway opening program 150 may identify the activity as a vehicle unloading. In at least one embodiment, the contextual accessway opening program 150 may further utilize the on-board sensors to determine which vehicle door is to be utilized for the identified activity. For example, the contextual accessway opening program 150 may determine that the driver's side back door of a four-door sedan was loaded and should be utilized for the unloading activity.

In at least one embodiment, the on-board sensors and IoT sensors may be representative of IoT sensor set 125. Furthermore, the sensors of IoT sensor set 125 may include, but are not limited to, proximity sensors, accelerometers, infrared sensors, pressure sensors, light sensors, ultrasonic sensors, touch sensors, color sensors, humidity sensors, position sensors, magnetic sensors (e.g., Hall effect sensor), sound sensors (e.g., microphones), tilt sensors (e.g., gyroscopes), flow sensors, level sensors, strain sensors, and weight sensors.

Then, at 204, the contextual accessway opening program 150 identifies a contextual orientation of the access point based on environmental and historical information. Once the contextual accessway opening program 150 identifies the activity being performed by the user, the contextual accessway opening program 150 may proceed to identifying the orientation of the door based on the type of activity to be performed, the volume of the activity, entity type (e.g., human or robotic involvement) performing the activity, the type of vehicle involved, and equipment to be utilized in the activity. In at least one embodiment, since the various doors of the vehicle may be utilized for any number of activities and a different orientation may be utilized for each activity, the contextual accessway opening program 150 may maintain a repository, such as storage 124 or remote database 130, of historical door opening patterns and door orientations for various activities. For example, the contextual accessway opening program 150 may utilize the repository to determine the orientation when a tractor trailer is being unloaded with cargo needing a forklift should be a ramp.

Similarly, the contextual accessway opening program 150 may analyze the environment surrounding the vehicle to determine the orientation most suitable for the terrain and obstacles present. For example, the contextual accessway opening program 150 may determine that the vehicle has parked next to obstacles that prevent a trailer door from fully opening in one direction but may allow the door to fully open if swung in another direction. In at least one embodiment, the environmental surroundings considered by the contextual accessway opening program 150 include, but are not limited to, surface slope, terrain type, weather conditions (e.g., precipitation occurring, wind presence, cloud cover, etc.), moveable obstacles surrounding vehicle, immoveable obstacles surrounding vehicle, and living entities surrounding vehicle.

In at least one other embodiment, the contextual accessway opening program 150 may consider attendant componentry installed on the vehicle when determining the contextual orientation to be utilized. For example, a vehicle may be equipped with one or more of foldable canopies, foldable steps, body or bumper cut-outs, pneumatic lifts, a lift gate, a tail gate, etc.

Next, at 206, the contextual accessway opening program 150 generates a plan to orient the door of the access point according to the identified contextual orientation. Once the contextual orientation into which the door is to be placed is identified, the contextual accessway opening program 150 may generate a plan to open the door to the identified orientation. Some orientations may be more simplistic than others. For example, opening the door to a ramp on a flat surface or swinging a door left or right may not require as much complexity as orienting a tractor trailer door to a set of stairs or an elevator. Similarly, the contextual accessway opening program 150 may determine door hinges to engage or disengage to open the door as well as whether any, and if so, which, hinges within the array of panels should be locked based on the contextual orientation. For example, if a door is to be oriented to a set of stairs but the vehicle is parked on a hill, the contextual accessway opening program 150 may generate the set of stairs differently than if the vehicle were parked on a flat surface.

Then, at 208, the contextual accessway opening program 150 performs the generated plan. Once the plan to open the door to the identified contextual orientation is generated, the contextual accessway opening program 150 may begin performing the plan by transmitting a signal to one or more supporting hydraulic arms that perform the required movement. Based on the magnitude and direction of applied pressure by the hydraulic arm, the vehicle door may begin opening to the contextual orientation.

Referring now to FIGS. 3A-3E, block diagrams of various orientations of a multi-hinged access door according to at least one embodiment. In FIG. 3A, a semi-tractor trailer 300 is depicted with a fully closed loading/unloading door 302 in a normal manner for transport. In FIG. 3B, the loading door has been oriented to a staircase 304 based on the contextual setting. In FIG. 3C, the loading door has been oriented to a sliding ramp 306 based on the contextual setting. In FIG. 3D, the loading door has been oriented to an extended sliding ramp 308 using the hydraulic arm to expand the length of the door. Finally, in FIG. 3E, the loading door has been converted to a hatchback 310 based on the contextual setting requiring the conversion to one or more pivot hinges on the top of the tractor trailer 300 that allow for the upward movement of the door. Furthermore, the door may be supported in such a fashion using the hydraulic arm or piston.

It may be appreciated that FIGS. 2 and 3A-3E provide only an illustration of one implementation and do not imply any limitations with regard to how different embodiments may be implemented. Many modifications to the depicted environments may be made based on design and implementation requirements. For example, in at least one embodiment, the contextual accessway opening program 150 may be capable of communicating with one or more other vehicles within a preconfigured distance of the subject vehicle when it is determined that the identified activity is a transfer of items from one vehicle to another. This communication may also be incorporated in the determination of the contextual orientation. For example, if the contextual accessway opening program 150 determines the activity to be performed is a transfer of times from one tractor trailer to another, the contextual accessway opening program 150 may orient the doors of each tractor trailer to be a bridge between the vehicles thereby allowing a secure walkway between the vehicles for item transfer.

Although the contextual accessway opening program 150 is discussed with various embodiments involving vehicles, the contextual accessway opening program 150 may be utilized with any entity, moveable or immoveable, that has a door and is, or can be, equipped to maneuver the door to various positions, such as, but not limited to, transportation shipping cargo containers and freight containers.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
determining, by a processor, an occurrence of an activity utilizing a vehicle access point is to occur within a preconfigured period of time;
identifying a contextual orientation of a door of the vehicle access point based on environmental data and historical data;
generating a plan to orient the door according to the identified contextual orientation; and
performing the generated plan.

2. The method of claim 1, wherein the door consists of an array of flat surface panels connected by hinges aligned in parallel and capable of movement in two directions.

3. The method of claim 1, wherein the door is supported by a support device, and wherein the support device is selected from a group consisting of a piston, a hydraulic arm, a pneumatic device, or a motor.

4. The method of claim 1, wherein the occurrence is determined using one or more on-board sensors embedded or communicatively coupled to the vehicle.

5. The method of claim 1, wherein identifying the contextual orientation further comprises:
identifying an orientation of the door based on a type of activity to be performed, a volume of the activity, an entity type performing the activity, a type of vehicle involved, and equipment to be utilized in the activity.

6. The method of claim 1, wherein the vehicle further comprises any entity, moveable or immoveable, that has a door and is, or can be, equipped to maneuver the door to various positions.

7. The method of claim 1, wherein the environmental information is selected from a group consisting of surface slope, terrain type, weather conditions, moveable obstacles surrounding vehicle, immoveable obstacles surrounding vehicle, and living entities surrounding vehicle.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
determining an occurrence of an activity utilizing a vehicle access point is to occur within a preconfigured period of time;
identifying a contextual orientation of a door of the vehicle access point based on environmental data and historical data;
generating a plan to orient the door according to the identified contextual orientation; and
performing the generated plan.

9. The computer system of claim 8, wherein the door consists of an array of flat surface panels connected by hinges aligned in parallel and capable of movement in two directions.

10. The computer system of claim 8, wherein the door is supported by a support device, and wherein the support device is selected from a group consisting of a piston, a hydraulic arm, a pneumatic device, or a motor.

11. The computer system of claim 8, wherein the occurrence is determined using one or more on-board sensors embedded or communicatively coupled to the vehicle.

12. The computer system of claim 8, wherein identifying the contextual orientation further comprises:
identifying an orientation of the door based on a type of activity to be performed, a volume of the activity, an entity type performing the activity, a type of vehicle involved, and equipment to be utilized in the activity.

13. The computer system of claim 8, wherein the vehicle further comprises any entity, moveable or immoveable, that has a door and is, or can be, equipped to maneuver the door to various positions.

14. The computer system of claim 8, wherein the environmental information is selected from a group consisting of surface slope, terrain type, weather conditions, moveable obstacles surrounding vehicle, immoveable obstacles surrounding vehicle, and living entities surrounding vehicle.

15. A computer program product, the computer program product comprising:
one or more computer-readable tangible storage medium and program instructions stored on at least one of the one or more tangible storage medium, the program instructions executable by a processor capable of performing a method, the method comprising:
determining an occurrence of an activity utilizing a vehicle access point is to occur within a preconfigured period of time;
identifying a contextual orientation of a door of the vehicle access point based on environmental data and historical data;
generating a plan to orient the door according to the identified contextual orientation; and
performing the generated plan.

16. The computer program product of claim 15, wherein the door consists of an array of flat surface panels connected by hinges aligned in parallel and capable of movement in two directions.

17. The computer program product of claim 15, wherein the door is supported by a support device, and wherein the support device is selected from a group consisting of a piston, a hydraulic arm, a pneumatic device, or a motor.

18. The computer program product of claim 15, wherein the occurrence is determined using one or more on-board sensors embedded or communicatively coupled to the vehicle.

19. The computer program product of claim 15, wherein identifying the contextual orientation further comprises:
identifying an orientation of the door based on a type of activity to be performed, a volume of the activity, an entity type performing the activity, a type of vehicle involved, and equipment to be utilized in the activity.

20. The computer program product of claim 15, wherein the vehicle further comprises any entity, moveable or immoveable, that has a door and is, or can be, equipped to maneuver the door to various positions.
